(19) United States
(12) Patent Application Publication
(10) Pub. No.: US 2016/0003750 A1
(43) Pub. Date: Jan. 7, 2016

(54) METHOD AND APPARATUS FOR TITRATION

(71) Applicant: OPSIS AB, Furulund (SE)

(72) Inventors: Anders ROSLUND, Malmö (SE); Anette HULTMAN, Löddeköping (SE); Olle LUNDSTRÖM, Lund (SE); Ragnar ÅKESSON, Ängelholm (SE)

(73) Assignee: OPSIS AB, Furulund (SE)

(21) Appl. No.: 14/765,136

(22) PCT Filed: Feb. 4, 2013
(86) PCT No.: PCT/EP2013/052129

§ 371 Date: Jul. 31, 2015

(51) Int. Cl. G01N 21/79; G01N 31/00; G01N 31/16

(52) U.S. Cl. CPC G01N 21/79; G01N 31/16; G01N 31/002

(57) ABSTRACT

Method for titration comprising: providing a solution comprising at least one titrand and at least one indicator; providing a titrant; performing titration by repeatedly: transmitting light through the solution; measuring an intensity of light transmitted through the solution at a first wave length; measuring an intensity of light transmitted through the solution at a second wave length; comparing the measured intensities of light transmitted through the solution at the first and second wave lengths with a target value; and adding titrant to the solution at a rate based on said comparing.

### TECHNICAL FIELD

The present invention relates to a method for titration. The invention also concerns an apparatus for titration, and use of the apparatus.

### TECHNICAL BACKGROUND

Methods based on distillation followed by titration are commonly used in analysis of, for example, feed and food stuff. Examples of this include the Kjeldahl method for determination of nitrogen/protein or nitrate using Devarda's alloy, determination of volatile acids/bases as well sulfur dioxide in a wide range of sample types.

Distillations are made in order to separate the analyte from a sample matrix so that a direct titration method can be used to determine the analyte without negative influences from other substances in the sample matrix. There are several types of titration procedures, based on several different chemical reactions using a wide range of indicators for visual detection of the end point during titration. In Kjeldahl analysis typically bromocresol green—methyl red indicator mixtures are used to detect the end point but also other indicators can be used.

A titration procedure typically involves addition of a titrant of known concentration to the titrand, such as an unknown reactant or analyte with an unknown concentration, to the point where a reaction between titrant and titrand goes to completion. As the total volume of the titrant added to the sample at the endpoint may be measured with high accuracy and as the stoichiometry of the titrand—titrant reaction may be known, the original concentration of the unknown reactant may be determined. Problems related to such procedure include determining with high accuracy the endpoint or the exact endpoint of the titration. Traditionally titrations are performed in static conditions, i.e. all of the titrand is already from the start contained within the volume to which the titrant is added. In apparatus combining distillation and titration, the titration proceeds simultaneously with the distillation. Such titration in parallel with the distillation saves time and may considerably reduce total analysis time. The titrand is continuously transferred into a collection cell to which the titrant is added. Determination of the exact end point for such a procedure is more difficult as compared to a static system due to a dynamic process.

In a typical Kjeldahl analysis ammonia is distilled from a digested sample into a collection vessel containing boric acid with bromocresol green—methyl red indicator mixture. During titration a burette is regulated to deliver titration acid to the collection vessel. It may be desired that the volume added to reach the end point of the titration is measured with high accuracy. At the end point a mixture with neutral grayish color is obtained. During the distillation ammonia is gradually released from the sample and transferred into the collection vessel, in the beginning nothing is transferred for a while and then suddenly the rate of ammonia transfer increases rapidly and finally slows down more and more to the end when all of the ammonia has been removed from the sample solution. The more ammonia that is transferred to the collection vessel the stronger green color is obtained and when titrant is added the strength of this color is reduced and the color is moved towards the red end of the color scale. The task of the system that regulates the burette is to proceed at as high speed as possible without passing the final endpoint, ending up at the neutral greyish color obtained at the stoichiometric endpoint. As the rate of ammonia transfer changes over time this is a delicate task which is further complicated by the change in behavior of the system that is obtained once the burette needs refilling during the distillation process. In such a case the gradual decrease in ammonia concentration within the receiving vessel is disrupted as the collection vessel receives ammonia without any titration running in parallel.

The US patent with number U.S. Pat. No. 3,723,062 discloses a method and an instrument for titration using an indicator which changes from one color to another at an end-point. The instrument is directing two beams of light through an acid mixture, colorimetric responsive to the concentrations of the acid and base forms. Two light detectors provide a pair of signals which responds to the concentration of one form of the indicator. The endpoint is indicated when the pair of signals reaches a predetermined value. It would be desired to be able to perform such a method with decreased analysis time.

### SUMMARY OF THE INVENTION

Purposes of the present invention include providing solutions to problems related to prior art.

According to a first aspect of the present invention, there is provided a method for titration, comprising: providing a solution comprising at least one titrand and at least one indicator; providing a titrant; performing titration by repeatedly: transmitting light through the solution, measuring an intensity of light transmitted through the solution at a first wave length, measuring an intensity of light transmitted through the solution at a second wave length, comparing the measured intensities of light transmitted through the solution at the first and second wave lengths with a target value, and adding titrant to the solution at a rate based on said comparing.

The providing of a solution comprising at least one titrand and at least one indicator may be an efficient means of enable titration of the titrand, for example by adding titrant to the solution.

It is realized that repeatedly transmitting light through the solution means that the light should be transmitted at least when said measuring an intensity is performed. In practice, the light may be, for example, transmitted continuously through-out the titration, or only during the measuring. Thus, the light may be transmitted continuously or at intervals, as long as the light is transmitted during the measuring.

Measuring an intensity of light transmitted through the solution may be performed at at least two wave lengths, such as the first and second wave lengths, and a third or more wave length(s). Said transmitting light through the solution may be transmitting light with broad or narrow spectrum. For example light having a continuous spectrum over the visible spectrum may be used, or over a part of the visible spectrum. The spectrum may at least to a part overlap a non visible spectrum. The light may be light from a light source selected from the group consisting of light emitting diodes, gas discharge lamps, fluorescent lamps and incandescent or filament lamps, or combinations thereof. A plurality of light sources of the same type may also be combined.

Said comparing the measured intensity may give an indication of how close to the target value the compared value is. Repeating the measuring and comparing may give an indication of the progress towards the target value. If the target value is close, the rate of adding adding titrant may be decreased, if the target value is further away, the rate of adding titrant may still be high. For example, if the target value is further away compared to the previous comparing, the rate may be increased. For example, the rate of adding titrant may be high at the start of titration and decreased when the target value is approached.

The first and second wave lengths may be selected such that they comprise wave lengths of the light transmitted through the indicator before, after and/or at the equivalence point.

According to one embodiment, the target value may represent predetermined light intensities at the first wave length and the second wavelength, respectively.

According to one embodiment, the target value may represent light intensities at the first wave length and the second wavelength, at an equivalence point for the reaction between the titrand and the titrant, or an end point of the indicator. Thus, repeating the comparing may give an indication of how far from the equivalence point or the endpoint the titration is and the rate of adding titrant may be adjusted accordingly. For example, if the end point is far away, the rate may be high, thus keeping the titration efficient and at high rate. For example, if the end point is closer, the titrant may be added at slower rate, such that the endpoint, or equivalence point, is not being passed by addition of too much titrant, such that titration with high accuracy may be achieved.

According to one embodiment, the first and second wave lengths may be selected such that they represent colours of the indicator. For example, if the indicator is red at a higher pH on one side of the equivalence point or end point, and green at a lower pH on the other side of the equivalence point or the end point, the first wave length may be selected such that it corresponds to green light and the second wave length may be selected such that it corresponds to red light. The first and second wave lengths may be represented by a single wave length, or a spectrum comprising a range of wave lengths, or an interval of wave lengths, respectively.

According to one embodiment, said comparing may include determining a ratio between the first measured light intensity and the second measured light intensity, and comparing the ratio with the target value; wherein the target value represents a predetermined ratio of light intensities at the first and second wavelength; or light intensities at the first wave length and the second wavelength, at an equivalence point for the reaction between the titrand and the titrant, or at an end point of the indicator.

Determining the ratio between the first measured light intensity and the second measured light intensity, may result in an efficient value for comparing. According to one embodiment, said comparing may include determining a point in a vector space, the point being represented by the first measured light intensity and the second measured light intensity, the target value being represented by a point in the vector space, and determining a distance between the points in the vector space. The vector space may be efficient to determine if the target value is far away or not. Further, the vector space may be efficient for two or more transmitted wave lengths. For example the first and the second and in addition a third and/or a fourth wave length. It is realized that, for example, 2, 3, 4, 5, or more wave lengths may be used. For example, two to ten wavelengths, or two to a thousand wave lengths. By vector space is meant any n-dimensional space including a two dimensional space. The measured values of the wave lengths may represent elements of the point in the vector space. The number of measured values may thus determine the dimensions of the vector space in question.

According to one embodiment, the titrand may comprise ammonium. For example, if the titrand is obtained from the Kjeldahl method, the titrand may be ammonium.

According to one embodiment, the titration is of the type acid-base titration and the indicator is sensitive to changes in pH.

According to one embodiment, the titrand may be fed from a distiller. For example, the titrand may be fed from a Kjeldahl apparatus.

According to one embodiment, the titrand may be fed by means of a flow of fluid, such as a flow of gas or liquid.

According to one embodiment, the titrand may be fed during the titration. Thus, for example, the titration may take place in a vessel to which vessel new titrand is being fed, for example by means of a distillation flow from a Kjeldahl apparatus. Said adding titrant to the solution at a rate based on said comparing thus enables adjusting the adding of titrant based on the feed of titrand.

According to one embodiment, the first wave length may correspond to green light and the second wave length may correspond to red light.

Such first and second wave lengths may be suitable, for example, together with indicators bromocresol green and methyl red. According to one embodiment said at least one indicator may be bromocresol green and methyl red.

According to a second aspect of the present invention, there is provided an apparatus for titration comprising: a titration vessel; a detector; a light source; a titrant dosing device; and a control device; wherein
the titration vessel is arranged to hold a solution comprising at least one titrand, and to receive a flow of titrant solution from the titrant dosing device; the detector is arranged to measure an intensity of light transmitted from the light source through the solution at a first wave length, and an intensity of light transmitted from the light source through the solution at a second wave length; and the control device is arranged to compare the measured intensities of light transmitted through the solution at the first and second wave lengths with a target value, and to control the flow of titrant solution from the titrant dosing device at a rate based on said comparing.

According to one embodiment, the apparatus may further comprise means for receiving a flow of titrand.

According to one embodiment, the apparatus may further comprise means for receiving the titrand from a distiller.

Thus, for example a flow of titrand from a Kjeldahl apparatus may be received by the apparatus, and the apparatus may be used for efficient Kjeldahl analysis.

According to one embodiment, the apparatus may further comprise a distillation device, wherein the titrand may be obtained from the distillation device.

According to a third aspect, there is provided a use of the apparatus according to the second aspect for titration.

Embodiments and discussions with regard to the first aspect may also be relevant with regard to the second aspect or third aspect. References to these embodiments are hereby made, where relevant.

The above described aspects and other features are exemplified by the following figures and detailed description.

### BRIEF DESCRIPTION OF THE DRAWINGS

FIG. 1 is a schematic illustration of an apparatus according to one embodiment.

### DETAILED DESCRIPTION OF THE INVENTION

It is understood that the detailed description below is intended to improve the understanding of the invention, and should not be interpreted as limiting the scope of the invention.

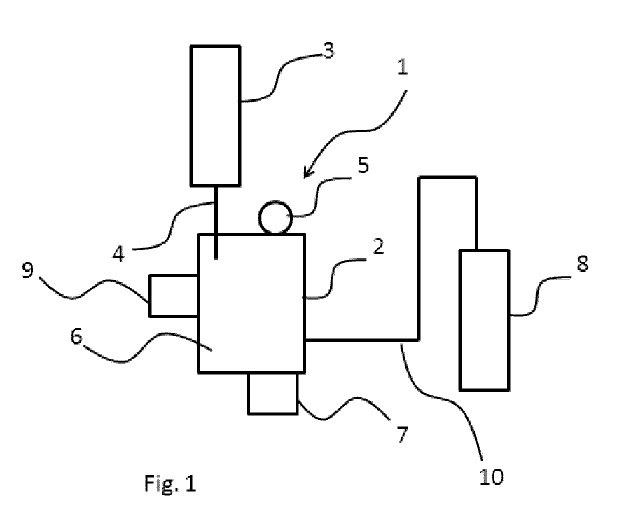

With reference to FIG. 1, there is illustrated an apparatus 1 for titration according to one embodiment, wherein titrand is fed as a flow of distillate. The apparatus comprises a titration vessel 2 which receives titrand, in this example fed from a distillation column 3 of a Kjeldahl apparatus through piping 4. It is realized that the titrand instead may be placed manually or by other means in the titration vessel, in which case the distillation column 3 may be omitted. The apparatus 1 further has a light source 5 which transmits light through a solution 6 in the titration vessel 2. A detector 7 is arranged to measure light transmitted through the solution at a plurality of wavelengths. A titrant dosing device 8, such as for example an automated burette or a pump, is providing a flow of titrant to the titration vessel 2 by means of piping 10 during the titration. The titration vessel 2, in addition to be arranged to hold the titrand and titrant, further may hold suitable reagents and indicators. A control device 9 is arranged to compare measured intensity of light transmitted through the solution at the plurality of wave lengths with a target value, and to control the flow of titrant solution from the titrant dosing device 8 at a rate based on said comparing.

### Example 1

To illustrate one embodiment of the invention an acid-base titration is exemplified. Regarding this example the titrand is assumed to be a base, B, having an equivalence point of around pH 6.0. A suitable indicator is selected, such as for example an indicator which may have an approximate range for colour change within the range of pH 5-7, wherein for this example it is assumed that the indicator changes from red (acid) to yellow (basic). An unknown amount of the base B is added as an aqueous solution to a vessel. The titrant in this example is selected to be aqueous HCl with known concentration. The solution of HCl, is provided by means of an automated burette, which burette may be controlled such that the rate of the solution fed to the vessel, for example expressed as micro litre per second, may be controlled.

Before the titration is started, the solution in the vessel, containing base B and indicator, would appear yellow due to the basicity of the solution. At the end-point the solution would appear red due to the decreased pH. Thus, the transmitted light would go from being yellow at the beginning of the titration towards red at the end of the titration, depending on the light source used. Thus, for this particular example, yellow and red light transmitted through the solution, could suitably be measured with respect to intensity. Suitable wave lengths for the yellow and red light would then be selected for measuring.

According to this example, the target value may for example be determined as the ratio I_{yellow light}/I_{red light} for transmitted light at or around the end point for the indicator. For example, the target value may be determined by adding titrant to a solution containing the indicator in the titration vessel until the color change occurs around the endpoint, and at these conditions measuring the intensities of the yellow and the red light and calculating the ratio I_{yellow light}/I_{red light}. According to another example, the target value may be calculated by performing a titration with the base B in presence of the indicator and calculating the ratio I_{yellow light}/I_{red light} around the end point. For the sake of the understanding of this example, it is assumed that the target value may be for example 0.1.

Titration could suitably be performed by:

1. transmitting light from a tungsten source, essentially comprising the entire visible spectrum, through the vessel

2. measuring the intensity of yellow light transmitted through the vessel

3. measuring the intensity of red light transmitted through the vessel

4. determining the ratio of transmitted yellow and red light, i.e. I_{yellow light}/I_{red light},

5. the ratio, I_{yellow light}/I_{red light}, would be compared with a target value, which in is this particular example may be for example 0.1.

6. the rate of adding of titrant is set dependent on the comparing, for this particular example, it may, for example, be decided that so long as the ratio is above 1, the rate is kept high, but when the ratio is below 1, the rate will be decreased linearly to a lower value until the target value is reached at which point the adding of titrant is stopped.

The steps 2-6 would be repeated at least twice.

A control device may be used. Input to the control device may be, for example, measured light intensities and target value. The control device may make calculations and perform the comparing. The control device may set the rate of the feed of titrant, for example by sending of signals to the automated burette. Further input data to the control device may be data used for setting the changes to the rate. The control device may be, for example, a computer with suitable software.

The amount of added titrant may after titration be determined from the known concentration and the added volume of the titrant solution. From the amount of added titrant, the amount of base B could be calculated and thus quantified.

Titration according to the above, is very beneficial as the titrant can be added at high rates in the beginning of the titration, but slowed down when the equivalence point or end-point is close, thus ensuring a rapid and efficient titration. In this example, the target value was selected as 0.1, i.e. corresponding to a solution which transmits higher intensity of red light than yellow light, which in this example was determined would be close to the end-point and the equivalence point of the titration.

It may, for example, be beneficial to perform a first titration wherein the ratio of transmitted light at the first wave length to transmitted light at the second wave length is determined at the equivalence or end-point and that this ratio is used as target value for consecutive titrations with the same titrand.

### Example 2

According to one example, the method according to an embodiment may be used for titrations wherein titrand is fed to the titration vessel during the titration. The same titrand, titrant and indicator as in the previous example 1 may be considered for this example. While in the previous example 1 all titrand was added the titration vessel at the beginning or before the titration, in this example, the titrand is fed the titration vessel from a reactor in which the titrand is produced. The feed of titrand to the titration vessel over time may vary. For example, initially a relatively low amount of titrand per unit of time may be fed the titration vessel, followed by a relatively high amount per unit of time, after which the amount per unit of time may be decreased to lower levels.

In this example, in the first part of the titration, corresponding to adding a relatively low amount of titrand per unit of time, the titration may be performed with relatively low addition rates of titrant, still with a state in the titration vessel being close to the equivalence point, then the feed of titrand increases, thus, resulting in an increased ratio I_{yellow light}/I_{red light}. The rate of addition of titrant would then be increased. Then, the amount of fed titrand per unit of time is decreased, the rate of adding titrant may then be decreased. Such a titration would be very rapid and accurate, as the rate of the addition of titrant would be adjusted to match the addition of titrand and the distance to the end-point or equivalence point. It is further realized that the benefits of the embodiment may be even more appreciated if the addition of titrand would vary even further. The method and any apparatus taking advantage of the method according to embodiments of the invention may adapt to such circumstances.

### Example 3

According to one example and embodiment of the invention, titration was performed in accordance with a Kjeldahl method using a Kjeldahl apparatus. Samples were prepared by weighing different amounts of (NH₄)₂Fe(SO₄)₂ as salt. As light source a Cree X-lamp, XP-G, model 2600K-3700 K CCT was used, and for detection of transmitted light a Hamamatsu, Digital Color Sensor, S-9706 was used detecting a broad spectral range including blue, green and red light, and the ratio of measured green and red light was calculated, for comparing with a target value. As receiver solution in the titration vessel a 1% boric acid solution with added indicators bromcresol green and methyl red was used.

Prior to the analysis a solution was made containing 30 ml receiver solution and 75 ml destilled water. HCl was added to reach a neutral grey colour. The ratio of green and red light was determined to be 0.75, which was used as target value for the experiment.

During titration, the ratio of measured transmitted green to red light was calculated and compared to the target value, and the automated burette feeding titrant to the titration vessel was controlled using these values according to table 1. It is evident from table 1, for example, that at or below the target value, no feeding of titrant is made, and further that at high ratios, i.e. at high levels of ammonia, the rate of feeding of titrant is high, compared to lower ratios. Thus, when high amounts of titrand is fed to the titration vessel from the distillation, the ratio of green to red light will be high and the rate of feeding titrant will be high. If the feed of titrand then is decreased the ratio of measured light will decrease, due to the addition of titrant, thus resulting in a decreased addition of titrant. When no more titrand is fed from the distillation device, the titration will proceed during which the ratio will decrease until the target value of 0.75 is reached, at which point no more titrant will be added. In this example, the dosing of titrant is not made continuously, but an addition of titrant is made according to table 1 dependent on the ratio of measured light, after which a new addition is made dependent on the calculated ratio and comparing it with the target value 0.75 according to table 1.

TABLE 1

| | Addition of |
|---|---|
| | titrant in volume |
| | units each |
| Ratio of measured | corresponding |
| green to red light | to 1.95 μL. |
| <0.75 | none |
| 0.75-0.80 | 1 |
| 0.80-0.85 | 5 |
| 0.85-0.90 | 10 |
| 0.90-0.95 | 25 |
| 0.95-1.00 | 50 |
| 1.00-1.05 | 75 |
| 1.05-1.10 | 100 |
| 1.10-1.15 | 150 |
| >1.15 | 250 |

Thirtyone different samples were analysed. Data regarding the samples and from the analysis is presented in table 2. Data was calculated as known in the art.

TABLE 2
Weight [g] indicates the weight of (NH₄)₂Fe(SO₄)₂ in the sample.

| | | | | Amount | |
|---|---|---|---|---|---|
| | | added | | N in | |
| Sample | Weight | titrant | % N in | sample | |
| No. | [g] | [mL] | sample | [mg] | % Rec. |
| 1 | 1.46920 | 37.549 | 7.157 | 105.1 | 100.5 |
| 2 | 1.44590 | 36.920 | 7.150 | 103.4 | 100.4 |
| 3 | 0.92450 | 23.650 | 7.162 | 66.2 | 100.6 |
| 4 | 0.45250 | 11.632 | 7.192 | 33 | 101.0 |
| 5 | 0.63180 | 16.203 | 7.178 | 45 | 100.8 |
| 6 | 0.46370 | 11.830 | 7.138 | 33 | 100.3 |
| 7 | 0.69060 | 17.650 | 7.154 | 49 | 100.5 |
| 8 | 0.56900 | 14.500 | 7.131 | 41 | 100.2 |
| 9 | 0.76930 | 19.630 | 7.143 | 55 | 100.3 |
| 10 | 1.06050 | 27.109 | 7.157 | 76 | 100.5 |
| 11 | 0.86330 | 22.032 | 7.145 | 62 | 100.3 |
| 12 | 1.04230 | 26.830 | 7.207 | 75 | 101.2 |
| 13 | 1.49120 | 38.090 | 7.153 | 107 | 100.5 |
| 14 | 0.60610 | 15.550 | 7.180 | 44 | 100.8 |
| 15 | 0.91570 | 23.375 | 7.147 | 65 | 100.4 |
| 16 | 1.16930 | 29.850 | 7.148 | 84 | 100.4 |
| 17 | 0.83000 | 21.149 | 7.133 | 59 | 100.2 |
| 18 | 0.47170 | 12.010 | 7.124 | 34 | 100.1 |
| 19 | 0.85270 | 21.730 | 7.134 | 61 | 100.2 |
| 20 | 0.85420 | 21.690 | 7.108 | 61 | 99.8 |
| 21 | 0.69890 | 17.861 | 7.153 | 50 | 100.5 |
| 22 | 0.93060 | 23.690 | 7.127 | 66 | 100.1 |
| 23 | 0.91600 | 23.280 | 7.115 | 65 | 99.9 |
| 24 | 0.26270 | 6.700 | 7.129 | 19 | 100.1 |
| 25 | 0.40000 | 10.160 | 7.105 | 28 | 99.8 |
| 26 | 0.39200 | 9.930 | 7.086 | 28 | 99.5 |
| 27 | 0.43670 | 11.139 | 7.136 | 31 | 100.2 |
| 28 | 0.40250 | 10.310 | 7.165 | 29 | 100.6 |
| 29 | 0.90580 | 23.063 | 7.128 | 65 | 100.1 |
| 30 | 0.35700 | 9.210 | 7.215 | 26 | 101.3 |
| 31 | 0.33080 | 8.450 | 7.143 | 24 | 100.3 |

In this example, the percent nitrogen, % N, in the sample is known to be 7.12%, as the sample is (NH₄)₂Fe(SO₄)₂. The relative standard deviation was calculated to be 0.394%. It can be concluded that the embodiment provides titration with high accuracy. The analysis time can be kept low or minimised as the addition of titrant may be performed at high rates.

For this example, the ratio of measured green light to red light was monitored or calculated at very high sampling rates, or essentially continuously, and prior to each addition of titrant the current ratio is used for comparing with the target value. It is realized, that the ratio alternatively, for example, may be calculated only prior to each possible addition of titrant.

It is further realized that even though the titrant was added in discrete portions, and not continuously, the addition of titrant is considered to have a rate.

The measured values of the first and second wave lengths may vary greatly depending on the configuration of the apparatus used for performing the titration. For example, the sensor used may not be equally sensitive to light of the wavelengths used. Also the light source may emit light of different intensities for the wavelengths used. In addition to this the components of apparatus may absorb or attenuate light of different wavelengths to different degree. Given this, the skilled person realizes that it may be advantageous to modify the measured values before calculating the ratio. For instance, if a measured value is significantly larger than another value, it may be advantageous to scale one or both of the measured values before calculating the ratio. By doing this a ratio which is adapted to the specific apparatus used may be calculated. Further, the skilled person realizes that the measured values may be subjected to various mathematical operations before calculating the ratio, without departing from the scope of the invention.

1. Method for titration, comprising,
providing a solution comprising at least one titrand and at least one indicator
providing a titrant,
performing titration by repeatedly:
transmitting light through the solution,
measuring an intensity of light transmitted through the solution at a first wave length,
measuring an intensity of light transmitted through the solution at a second wave length,
comparing the measured intensities of light transmitted through the solution at the first and second wave lengths with a target value, and
adding titrant to the solution at a rate based on said comparing.

2. The method according to claim 1, wherein the target value represents predetermined light intensities at the first wave length and the second wavelength, respectively.

3. The method according to claim 1, wherein the target value represents light intensities at the first wave length and the second wavelength, at
an equivalence point for the reaction between the titrand and the titrant, or
an end point of the indicator.

4. The method according to claim 1, wherein said comparing includes determining a ratio between the first measured light intensity and the second measured light intensity, and comparing the ratio with the target value, wherein
the target value represents a predetermined ratio of light intensities at the first and second wavelength, or
light intensities at the first wave length and the second wavelength, at an equivalence point for the reaction between the titrand and the titrant, or an end point of the indicator.

5. The method according to claim 1, wherein said comparing includes determining a point in a vector space, the point being represented by the first measured light intensity and the second measured light intensity, the target value being represented by a point in the vector space, and determining a distance between the points in the vector space.

6. The method according to claim 1, wherein the titrand comprises ammonium.

7. The method according to claim 1, wherein the titration is of the type acid-base titration and the indicator is sensitive to changes in pH.

8. The method according to claim 1, wherein the titrand is fed from a distiller.

9. The method according to claim 1 wherein the titrand is fed by means of a flow.

10. The method according to claim 1, wherein the first wave length corresponds to green light and the second wave length corresponds to red light.

11. Apparatus for titration comprising,
a titration vessel, a detector, a light source, a titrant dosing device, and a control device, wherein
the titration vessel is arranged to hold a solution comprising at least one titrand, and to receive a flow of titrant solution from the titrant dosing device,
the detector is arranged to measure an intensity of light transmitted from the light source through the solution at a first wave length, and an intensity of light transmitted from the light source through the solution at a second wave length, and
the control device is arranged to compare the measured intensities of light transmitted through the solution at the first and second wave lengths with a target value, and to control the flow of titrant solution from the titrant dosing device at a rate based on said comparing.

12. The apparatus according to claim 11, the apparatus further comprises means for receiving a flow of titrand.

13. The apparatus according to claim 11, wherein the apparatus further comprises means for receiving the titrand from a distiller.

14. The apparatus according to claim 11, wherein the apparatus further comprises a distillation device.

15. Use of the apparatus according to claim 11 for titration.
